(19) United States
(12) Patent Application Publication
(10) Pub. No.: US 2026/0302269 A1
(43) Pub. Date: Oct. 1, 2026

(54) METHODS AND SYSTEMS FOR COMMERCIALLY PRODUCING TUBULAR SOLID OXIDE FUEL CELLS

(71) Applicant: WATT Fuel Cell Corp., Mount Pleasant, PA (US)

(72) Inventors: Caine Finnerty, Belle Vernon, PA (US); Mathew Isenberg, North Canton, OH (US); Anthony Dugan, Irwin, PA (US)

(21) Appl. No.: 19/478,072

(22) PCT Filed: Apr. 24, 2024
(86) PCT No.: PCT/US2024/025936

§ 371 Date: Oct. 23, 2025

Related U.S. Application Data
(60) Provisional application No. 63/498,118, filed on Apr. 25, 2023.

(51) Int. Cl. H01M 8/00; B28B 11/14; B28B 17/00; B28B 21/44; C04B 35/622; C04B 35/64; H01M 8/12; H01M 8/124

(52) U.S. Cl. CPC H01M 8/004; B28B 11/14; B28B 17/0072; B28B 21/44; C04B 35/62218; C04B 35/64; H01M 8/124; C04B 2235/6028; C04B 2235/612; H01M 2008/1293

(57) ABSTRACT

The present teachings relate to methods and systems for making tubular ceramic green bodies that are convertible to tubular solid oxide fuel cells.

### CROSS-REFERENCE TO RELATED APPLICATION

This application claims the benefit of and priority to U.S. Provisional Patent Application No. 63/498,118, filed Apr. 25, 2023, the entire disclosure of which is hereby incorporated by reference in its entirety for all purposes.

### FIELD

The present teachings relate to methods and systems for making tubular ceramic green bodies that are convertible to tubular solid oxide fuel cells.

### BACKGROUND

Tubular ceramic structures are known for use as heat exchangers where corrosive liquids or gases are encountered, recuperators, catalyst bodies, as components of fuel cells, particularly solid oxide fuel cells (SOFCs), and in a variety of other applications. SOFCs have gained attention in recent years for their green energy production as well as for portable and distributed means for providing electricity in remote places or residential applications. Among the various designs, micro-or macro-tubular SOFCs provide a number of advantages.

Tubular ceramic structures for SOFCs can be produced using the methods described in U.S. Pat. No. 9,542,548, which are capable of producing a tubular ceramic structure over a broad range of wall thicknesses, i.e., from the very thin to the very thick, does not require close attention to and control of the conditions of drying, is readily capable of altering or modifying the composition of the tubular product for a defined portion thereof, and does not require the use of a tubular substrate which is destined to become a permanent component of the product. Although the techniques described therein are effective, commercial SOFC unit production requires thousands of tubular SOFCs, especially when using bundles of micro-or macro-tubular SOFCs.

Thus, there is a need to improve the efficiency of making tubular ceramic green bodies for use as tubular solid oxide fuel cells as well as improved methods for cutting tubular ceramic green bodies that do not damage the resulting green body structure.

### SUMMARY

In light of the foregoing, the present teachings provide methods and systems that can improve the efficiency of making tubular ceramic green bodies, which are precursors to tubular SOFCs. The methods and systems of the present teachings are especially useful for the commercial production of such tubular SOFCs as the methods can be automated. The methods can involve the inspection of the tubular ceramic green body as it is being produced so that those tubular ceramic green bodies with a defect can be removed and recycled prior to firing the tubular ceramic green body.

More specifically, the methods of the present teachings generally include applying different ceramic-forming layers about a spindle to form a tubular ceramic green body, where the ceramic forming layers can be completely different in content, e.g., an anode-forming layer versus an electrolyte-forming layer, or be of a minor variation in its composition, e.g., while creating the anode-forming layer the elemental composition of the anode-forming layer can be varied for a particular feature or structure need. At various points during the process of forming the tubular ceramic green body, it can be inspected for defects and dimensions so that defective tubular ceramic green bodies can be recycled if subsequently added ceramic-forming layers are unable to cure the defect and/or dimensions. The dimensions of the ceramic green bodies can be measured in real time so that the thickness of the layers can be carefully controlled as well as indicating when additional layer(s) are needed to meet specifications.

Finally, the present teachings provide methods of cutting such tubular ceramic green bodies without damaging the underlying structure so that a clean cut is realized.

These and other features of the present teachings will be described more fully herein.

Thus, in one aspect, the present teachings provide a method for producing tubular ceramic green bodies comprising:
providing a cartridge comprising a plurality of mandrel-spindle assemblies, the lengths of the plurality of mandrel-spindle assemblies being parallel to each other and in the same horizontal plane along the cartridge, wherein the cartridge is adapted to rotate each of the plurality of mandrel-spindle assemblies and wherein each of the mandrel-spindle assemblies comprises a mandrel component and a spindle component, the mandrel component being a heat shrinkable tube, a fugitive tube or a coating on the spindle component, the external surface of which corresponds to the internal surface of the tubular ceramic green body to be produced and the internal surface of which defines a bore, the spindle component being in close fitting but removable contact therewith;
rotating the plurality of mandrel-spindle assemblies and applying an anode-forming layer to each of the respective mandrels of the plurality of rotating mandrel-spindle assemblies of the cartridge to form a plurality of anode-forming green bodies about each respective spindle;
inspecting each of the plurality of anode-forming green bodies for defects;
rotating the plurality of anode-forming green bodies and applying an interface-forming layer to each of the respective anode-forming green bodies of the plurality of rotating anode-forming green bodies of the cartridge to form a plurality of multiple layered green bodies about each respective spindle;
inspecting each of the plurality of multiple layered green bodies for defects;
rotating the plurality of multiple layered green bodies and applying an electrolyte-forming layer to each of the respective multiple layered green bodies of the plurality of rotating multiple layered green bodies of the cartridge to form a plurality of tubular ceramic green bodies about each respective spindle;
inspecting each of the plurality of tubular ceramic green bodies for defects; and
removing any spindle comprising a tubular ceramic green body which was identified as having a defect during the inspections, prior to firing the tubular ceramic green body.

In a related aspect, the present teachings provide a system for producing tubular ceramic green bodies comprising:
a cartridge comprising a plurality of mandrel-spindle assemblies, the lengths of the plurality of mandrel-spindle assemblies being parallel to each other and in the same plane along the cartridge, wherein the cartridge is adapted to rotate each of the plurality of mandrel-spindle assemblies and wherein each of the mandrel-spindle assemblies comprises a mandrel component and a spindle component, the mandrel component being a heat shrinkable tube, a fugitive tube or a coating on the spindle component, the external surface of which corresponds to the internal surface of the tubular ceramic green body to be produced and the internal surface of which defines a bore, the spindle component being in close fitting but removable contact therewith;
a first printer station, wherein an anode-forming layer is applied to each of the respective mandrels of a plurality of rotating mandrel-spindle assemblies of the cartridge to form a plurality of anode-forming green bodies about each respective mandrel;
a second printer station, wherein an interface-forming layer is applied to each of the respective anode-forming green bodies of a plurality of rotating anode-forming green bodies of the cartridge to form a plurality of multiple layered green bodies about each respective mandrel;
a third printer station, wherein the electrolyte-forming layer is applied to each of the respective multiple layered green bodies of a plurality of rotating multiple layered green bodies of the cartridge to form a tubular ceramic green body;
an inspection station, wherein the anode-forming layer, the interface-forming layer, and the electrolyte-forming layer are inspected for defects after their formation and the identity of any mandrel-spindle assembly of the cartridge having any defects is recorded; and
a controller to automate the movement of the cartridge from the first print station to the inspection station, to the second printer station and the inspection station, and to the third printer station and the inspection station.

In another aspect, the present teachings provide a method of forming multiple tubular ceramic green bodies, for example, about one spindle, comprising:
providing a cartridge comprising a plurality of mandrel-spindle assemblies, the lengths of the plurality of mandrel-spindle assemblies being parallel to each other and in the same horizontal plane along the cartridge, wherein the cartridge is adapted to rotate each of the plurality of mandrel-spindle assemblies and wherein each of the mandrel-spindle assemblies comprises a mandrel component and a spindle component, the mandrel component being a heat shrinkable tube, a fugitive tube or a coating on the spindle component, the external surface of which corresponds to the internal surface of the tubular ceramic green bodies thereon and the internal surface of which defines a bore, the spindle component being in close fitting but removable contact therewith, and a tubular ceramic green body about each mandrel-spindle assembly; and
cutting with a laser the tubular ceramic green bodies into multiple, smaller tubular ceramic green bodies along each mandrel-spindle assembly.

The foregoing as well as other features and advantages of the present teachings will be more fully understood from the following figures, description, examples, and claims.

### DESCRIPTION OF THE DRAWINGS

It should be understood that the drawings described below are for illustration purposes only. Like numerals generally refer to like parts. The drawings are not necessarily to scale, with emphasis generally being placed upon illustrating the principles of the present teachings. The drawings are not intended to limit the scope of the present teachings in any way.

FIG. 1 is a schematic diagram of a perspective view of an embodiment of the present teachings showing a mandrel-spindle assembly having a partial anode-forming layer applied thereto.

FIG. 2 is a schematic diagram of a perspective view of an embodiment of the present teachings showing a cartridge including seven mandrel-spindle assemblies.

FIGS. 3A-3C are cross-sectional views of a mandrel-spindle assembly with anode-forming layers being applied with their outside diameters (and thickness) being measured using an outside diameter measurement device.

FIG. 4 is a schematic diagram of a top view of an embodiment of a system of the present teachings showing a storage station, printer stations, an inspection station including a real time outside diameter measurement device, a laser cutting station including a laser, and a robotic tray that can move the cartridges to and from each of the stations.

FIG. 5 is a schematic diagram of a top view of an embodiment of a system of the present teachings showing a storage station, three printer stations, three inspection stations, a laser cutting station and a conveyor belt that can move the cartridges to and from each of the stations.

### DETAILED DESCRIPTION

It now has been discovered that there are systems and methods for commercially producing tubular ceramic green bodies that can be converted into tubular SOFCs such as micro-and macro-tubular SOFCs for fuel cell bundles. The systems and methods generally include multiple printer stations for applying ceramic-forming layers, and one or more inspection stations. The systems and methods can also include a laser cutting station including a laser. The inclusion of inspection of the tubular ceramic green bodies as they are being prepared to identify defects and dimensions permits such defective tubes from being moved further in production, for example, being fired and prepared into a fuel cell unit, only to fail in the final product. The methods and system can include measuring in real time the outside diameter of a ceramic-forming layer as it is being applied for uniformity among the tubular ceramic green bodies among other reasons.

The systems and methods can include a storage station for maintaining a plurality of cartridges for use in the methods of the present teachings. The storage station can maintain cartridges ready for the application of ceramic-forming layers and/or cartridges with completed tubular ceramic green bodies. In some embodiments, more than one storage station is present such that the cartridges with finished products can be stored in a dedicated storage station and cartridges ready for production can be stored in another storage station, each with the appropriate active environmental controls, for example, for temperature and humidity control.

The systems of the present teachings can include a controller for computer related operation of the methods, for example, use of robotic equipment for the movement of the cartridges to different stations of the system. The robotic equipment can take a variety of forms and for simplicity, a “robotic tray” is used herein to reference such robotic equipment, which can include a robotic arm and movement means such as a wheeled robotic device or a device on a track or rail that can move to and from the different components and stations of the system to place in and remove the cartridges from each station.

The systems and methods also can include using a laser to cut the tubular ceramic green bodies into pre-determined lengths, where the ends of the tubes are evenly cut and have a perpendicular structure, thereby avoiding some of the difficulties with other cutting methods and systems. The laser can also be used to cut holes in the tubular ceramic green bodies and/or to form tapered ends for manifolding and current collection. Other shapes and apertures may be formed as well depending on the particular application and need.

With automation of the preparation of the tubular ceramic green bodies, the systems of the present teachings can be set up in a clean room to minimize human intervention and error into the process, which can be nearly continuous operation. For example, there can be an intermediary room for the exchange of storage stations to and from the interior and exterior of the clean room, for example, for movement of completed cartridges from the clean room, and the introduction of blank cartridges (mandrel-spindle assemblies). In addition, the clean room, intermediary room, and one or more stations can have environmental control features associated with them such that the temperature and humidity can be controlled as appropriate for the formation and storage of tubular ceramic green bodies of the present teachings.

To facilitate an understanding of the present teachings, a number of terms and phrases are defined below.

Unless defined otherwise, all technical and scientific terms used herein have the same meaning as commonly understood by one of ordinary skill in the art to which this invention belongs.

Throughout the application, where compositions are described as having, including, or comprising specific components, or where processes are described as having, including, or comprising specific process steps, it is contemplated that compositions of the present teachings also consist essentially of, or consist of, the recited components, and that the processes of the present teachings also consist essentially of, or consist of, the recited process steps.

In the application, where an element or component is said to be included in and/or selected from a list of recited elements or components, it should be understood that the element or component can be any one of the recited elements or components, or the element or component can be selected from a group consisting of two or more of the recited elements or components.

Further, it should be understood that elements and/or features of a composition, an apparatus, or a method described herein can be combined in a variety of ways without departing from the spirit and scope of the present teachings, whether explicit or implicit herein. For example, where reference is made to a particular structure, that structure can be used in various embodiments of apparatus of the present teachings and/or in methods of the present teachings, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

It should be understood that the expression “at least one of” includes individually each of the recited objects after the expression and the various combinations of two or more of the recited objects unless otherwise understood from the context and use. The expression “and/or” in connection with three or more recited objects should be understood to have the same meaning unless otherwise understood from the context.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

The use of the singular herein, for example, “a,” “an,” and “the,” includes the plural (and vice versa) unless specifically stated otherwise.

Where the use of the term “about” is before a quantitative value, the present teachings also include the specific quantitative value itself, unless specifically stated otherwise. As used herein, the term “about” refers to a ±10%, +5%, +3%, ±2%, or ±1% variation from the nominal value unless otherwise indicated or inferred.

Where a percentage is provided with respect to an amount of a component or material in a structure or a composition, the percentage should be understood to be a percentage based on weight, unless otherwise stated or understood from the context.

Where a molecular weight is provided and not an absolute value, for example, of a polymer, then the molecular weight should be understood to be an average molecule weight, unless otherwise stated or understood from the context.

It should be understood that the order of steps or order for performing certain actions is immaterial so long as the present teachings remain operable. Moreover, two or more steps or actions may be conducted simultaneously.

At various places in the present specification, numerical values are disclosed in groups or in ranges. It is specifically intended that the description include each and every individual subcombination of the members of such groups and ranges and any combination of the various endpoints of such groups or ranges. For example, an integer in the range of 0 to 40 is specifically intended to individually disclose 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, and 40, and an integer in the range of 1 to 20 is specifically intended to individually disclose 1, 2, 3, 4, 5, 6, 7, 8, 9, 10, 11, 12, 13, 14, 15, 16, 17, 18, 19, and 20.

The use of any and all examples, or exemplary language herein, for example, “such as” or “including,” is intended merely to illustrate better the present teachings and does not pose a limitation on the scope of the invention unless claimed. No language in the specification should be construed as indicating any non-claimed element as essential to the practice of the present teachings.

Terms and expressions indicating spatial orientation or altitude such as “upper,” “lower,” “top,” “bottom,” horizontal,” “vertical,” and the like, unless their contextual usage indicates otherwise, are to be understood herein as having no structural, functional or operational significance and as merely reflecting the arbitrarily chosen orientation of the various views of apparatus, devices, components, and/or features of the present teachings that may be illustrated in certain of the accompanying figures.

The expression “ceramic-forming layer” refers to generally any of the “-forming layers” as described herein, for example, an anode-forming layer, an interface-forming layer, an electrolyte-forming layer, an active catalyst-forming layer, and an inert-forming layer. The ceramic composition of ceramic-forming layer can also include a “cermet,” where a ceramic is mixed with a reducible metal oxide such as nickel oxide, copper oxide, iron oxide, and/or other transition metal oxides. Precious metals can also be incorporated into a ceramic-forming layer. After the tubular ceramic green body is formed and fired, the resulting body can be exposed to hydrogen at a predetermined temperature required to reduce the incorporated metal oxide phase thereby producing a “cermet.” In addition, as used herein, a “ceramic composition” can includes these components.

In these terms, the “-forming layer” refers to the slurry of ceramic composition that is applied to the rotating mandrel or to a prior applied layer and, in particular, to an amount of solvent that remains associated with the ceramic while additional layers are applied. In some embodiments, only solvent can be printed or sprayed onto an already formed ceramic-forming layer or green body layer.

It should be understood that the layers are generally applied with the anode layer first, followed by an interface layer and then finally the electrolyte layer. However, this basic structure can vary by the inclusion of intermittent inert layers and active catalyst layers. That is, an inert layer or an active catalyst layer can be the first layer, followed by other such layers or an anode layer. The anode layer can include inert layers and active catalyst layers interspersed therein, which can be similar for the interface layer including between the interface layer and the electrolyte layer. The anode-forming layer and the interface-forming layer can also include layers of different elemental composition, for example, layers with different percentages of and/or different ceramics, metal oxides and precious metals than in previously applied layers In certain embodiments, the anode layer and its components do not require an interface layer in between the electrolyte layer. Moreover, the present teaching include a tubular inert structure.

The “layers” as described herein can be thinner in a range of about 2 microns to about 5 microns to a thicker layer, which can be in a range of about 50 microns to about 800 microns, or 100 microns to about 500 microns. The complete tubular ceramic green body can be in a range of about 150 microns to about 1200 microns, for example, from about 200 microns to about 1100 microns, or from about 500 microns to about 1000 microns, or from about 750 microns to about 900 microns. Of course the layers and complete tubular ceramic body can be thinner or thicker depending on the particular application and design of tubular structure is desired.

As described herein, in one aspect, the present teachings provide a system for producing tubular ceramic green bodies. The system generally includes a cartridge comprising a plurality of mandrel-spindle assemblies, the lengths of the plurality of mandrel-spindle assemblies being parallel to each other and in the same plane along the cartridge. The cartridge is adapted or configured to rotate each of the plurality of mandrel-spindle assemblies, which can be at the same rate. Each of the mandrel-spindle assemblies comprises a mandrel component and a spindle component. The mandrel component is a heat shrinkable tube, a fugitive tube or a coating on the spindle component, the external surface of which corresponds to the internal surface of the tubular ceramic green body to be produced and the internal surface of which defines a bore, where the spindle component is in close fitting but removable contact therewith.

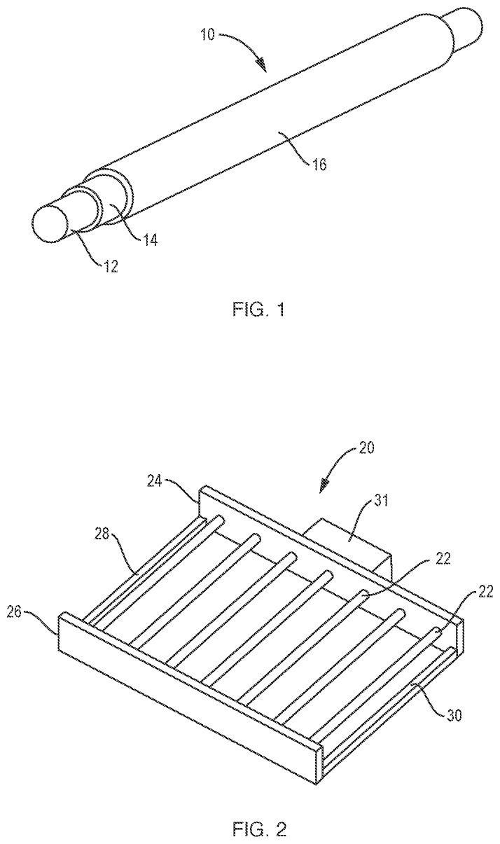

FIG. 1 shows an embodiment of a mandrel-spindle assembly 10 including an anode-forming layer. The spindle component 12 has a heat shrinkable tube, a fugitive tube or a coating on it 14. The heat shrinkable tube, fugitive tube or coating permit the formed tubular ceramic green body to be removed from the spindle while maintaining and not disrupting a bore through the tubular ceramic green body. FIG. 1 also shows a partial anode-forming layer 16 encompassing the mandrel component 14.

FIG. 2 shows an embodiment of a cartridge 20 of the present teachings having seven mandrel-spindle assemblies 22. As can be seen, the lengths of the plurality of mandrel-spindle assemblies are parallel to each other and in the same plane along the cartridge. The cartridge includes a frame that generally has a first side 24 and a second side 26 along with stabilizer bars 28, 30 across the two sides to secure the cartridge in a rectangular shape to maintain the parallel nature of the mandrel-spindle assemblies and secure them within the two sides. Although secured for rotating when the ceramic-forming layers are applied and possible laser cutting, the spindles (mandrel-spindle assemblies) can be independently and removably secured in the cartridge. The cartridge includes a rotation mechanism 31 for rotating the mandrel-spindle assemblies, which rotating can be at the same rate so that the application of the ceramic-forming layers can be uniform across the mandrel-spindle assemblies. However, the rotating mechanism can be adapted to rotate each spindle independently, and at different rates if desired.

More specifically, a rotation mechanism or rotation mechanisms can be in direct or indirect contact with the spindles on the first side of the frame. The rotation mechanism(s) can rotate each spindle individually or can rotate the plurality of spindles as a unit or sub-unit. To that end, the rotation mechanism(s) typically is adapted to rotate the plurality of spindles at the same speed for even application of the ceramic-forming layers on the rotating spindles. The rotation mechanism can be individual motors and gears and/or rotating belts for each spindle. More practical is a rotation mechanism that is an elliptical belt, or gears such as a gear train, or a combination thereof that are interconnected to move each of the spindles at the same time and at the same rate.

The system also generally includes a first printer station, wherein an anode-forming layer is applied to each of the respective mandrels of a plurality of rotating mandrel-spindle assemblies of the cartridge to form a plurality of anode-forming green bodies about each respective mandrel;
a second printer station, wherein an interface-forming layer is applied to each of the respective anode-forming green bodies of a plurality of rotating anode-forming green bodies of the cartridge to form a plurality of multiple layered green bodies about each respective mandrel;
a third printer station, wherein the electrolyte-forming layer is applied to each of the respective multiple layered green bodies of a plurality of rotating multiple layered green bodies of the cartridge to form a tubular ceramic green body;
an inspection station, wherein the anode-forming layer, the interface-forming layer, and the electrolyte-forming layer are inspected for defects after their formation and the identity of any mandrel-spindle assembly of the cartridge having any defects is identified; and
a controller to automate the movement of the cartridge from the first print station to the inspection station, to the second printer station and the inspection station, and to the third printer station and the inspection station.

In some embodiments, the system comprises a real time outside diameter measurement device associated with one or more of the first printer station, the second printer station, and the third printer station to determine the outside diameter of the respective applied ceramic-forming layer to a mandrel-spindle assembly. The real time outside diameter measurement device can be an independent measurement device that tracks back and forth with a printer head applying, for example, spraying, the ceramic-forming layers. The real time outside diameter measurement device can be a single point measurement device such that an initial reference measurement of the mandrel-spindle assembly is made, which includes the heat shrinkable or fugitive tube or coating, where the initial reference becomes the reference for the other mandrel-spindle assemblies of a cartridge. As the ceramic-forming layers are applied, the wall thickness can be compared to the reference to determine the thickness of the ceramic-forming layer being applied and the total thickness of the growing tubular structure or body.

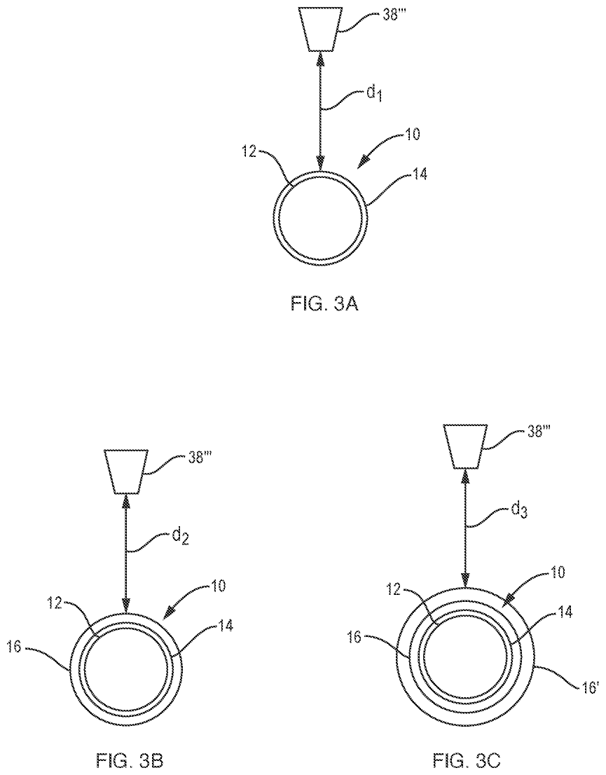

FIGS. 3A-3C depict such a measurement being made. FIG. 3A shows a cross-section of a mandrel-spindle assembly 10 with the spindle component 12 and mandrel component 14, for example, a heat shrinkable tube, a fugitive tube or a coating. The outside diameter measurement device 38′″, such a laser based device, can take an initial distance measurement to the mandrel-spindle assembly, which is a distance d₁. FIG. 3B shows a first ceramic-forming layer such as an anode-forming layer 16 being applied around the mandrel component 14, where the measured distance from the outside diameter measurement device 38′″ to the first ceramic-forming layer 16 is d₂, which when subtracted from d₁ (d₁-d₂), provides the thickness of the forming or formed first ceramic-forming layer. FIG. 3C shows the same or another ceramic-forming layer 16′ being applied, which can be of the same composition as the first ceramic-forming layer 16 or can be of a different composition. The measurement from the outside diameter measurement device 38′″ to this layer can be defined as ds. Accordingly, the thickness of the newly applied layer 16′ can be determined, de minus d₃ (d₂-d₃), as well as the total thickness of the tubular ceramic green body being formed d₁ minus d₃ (d₁-d₃). This process can be repeated for ceramic-forming layers as they are applied, In certain embodiments, when a certain thickness is achieved, it can trigger a change in the composition of the ceramic-forming green body being applied.

Another option would be to measure the outside diameter of the tubular ceramic structure being formed, where the measurement device is C-shaped, with multiple lasers mounted in the C-shaped body to generate an accurate outside diameter measurement. The C-shaped measurement device needs to automated to center itself about the mandrel-spindle assembly with an increasing wall thickness as the various ceramic-forming layers are applied. Such a device would center itself about a mandrel-spindle assembly after the printer head is out of the way, then take an outside diameter measurement. This measurement device can then move along the longitudinal axis of the same mandrel-spindle assembly to take an outside diameter measurement at another point or points along the mandrel-spindle assembly. After the measurements are completed, the C-shaped measurement device would move away from the cartridge so as not to impede the printer head's movement.

Monitoring the outside diameter of a ceramic-forming layer as it is being applied permits adjusting the thickness of a layer in real time, for example, needing to apply additional ceramic-forming composition to meet the dimensional specifications and/or triggering the application of a different ceramic-forming composition, such as an inert-forming composition. Adjusting the thickness of a ceramic-forming layer in real time also permits the covering of small defects, for example, pits inadvertently created in the layer being formed or a previously applied layer.

In certain embodiments, the system comprises a storage rack, wherein a plurality of the cartridges can be stored in horizontal fashion above one another but not in contact with the above and/or below adjacent cartridge(s).

In various embodiments, the system comprises a laser cutting station, wherein the cartridge comprising rotating tubular ceramic green bodies has its tubular ceramic green bodies exposed to a laser along a width of the tubular ceramic green bodies to form multiple tubular ceramic green bodies along the spindle having smaller lengths than before exposure to the laser.

In certain embodiments, the system comprises a robotic device to move the cartridge to and from the first printer station, the second printer station, the third printer station, the inspection station, and the laser cutting station. In particular embodiments, the robotic device moves the cartridge to and from a storage station, for example, from the storage station to the first printer station, and from the laser cutting station to the storage station.

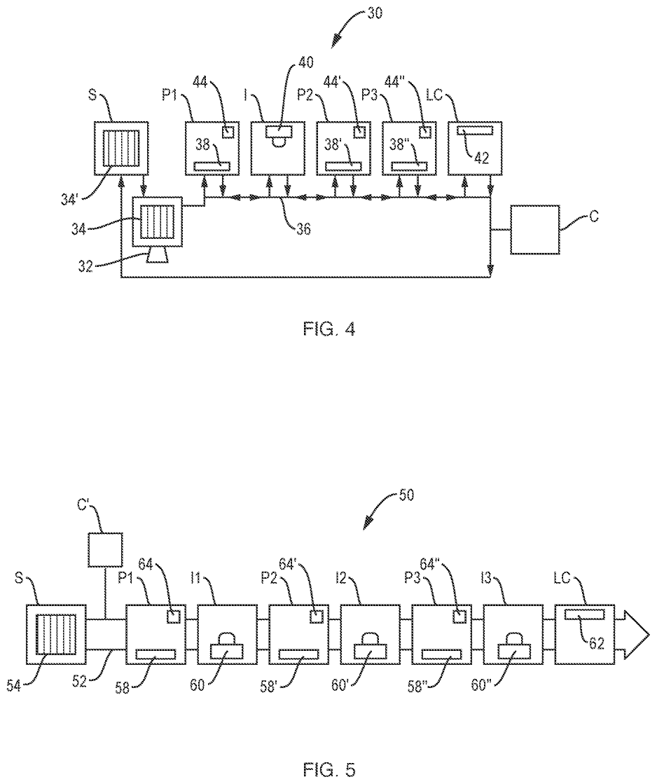

FIG. 4 shows an embodiment of a system of the present teachings having a storage station S, a first printer station P1, a second printer station P2, a third printer station P3, an inspection station I, and a laser cutting station LC. The system also includes a robotic tray 32 that can move a cartridge 34 to and from the various stations as shown by the arrowed lines 36 between and among the stations. The robotic tray 32 and its movements can be controlled by a controller C, which contains computer software program(s) to operate the overall movement and/or control of a cartridge within the system as well as other components of the system such as the inspection station camera and a real time outside diameter measurement device.

In some embodiments, the systems comprises a conveyor belt assembly to move the cartridge to and from the first printer station, the first inspection station, the second printer station, the second inspection station, the third printer station, the third inspection station, and the laser cutting station. In particular embodiments, the conveyor belt assembly moves the cartridge to and from a storage station, for example, from the storage station to the first printer station, and from the laser cutting station to the storage station.

FIG. 5 shows a schematic of a different embodiment of the present teachings, particularly a system 40 that uses a conveyor belt 52 to move a cartridge 54 along to the different stations, which can be similar to the methods as described in FIG. 4. However, the same inspection station cannot be used easily with conveyor belt system (although the conveyor belt could be moved in reverse back to a single inspection station but such a method would encumber a single conveyor belt line with one cartridge for its entirety in construction and inspection as well as laser cutting, shown in FIG. 5).

Nevertheless, as seen in FIG. 5, the system 50 includes three inspection stations I1, 12 and I3 so that the cartridge 54 follows a straight path on the conveyor belt 52 by first moving to the first printer station P1 that includes an outside diameter measurement device 58 and a printer head 64, then moving to the first inspection station I1, with camera 60. The cartridge 54 then moves to the second printer station P2 having a respective outside diameter measurement device 58′ and printer head 64′, then moving to the second inspection station 12 with camera 60′. The cartridge then moves to the third printer station P3 including an outside diameter measurement device 58″ and printer head 64″, then moving to the third inspection station I3 with camera 60″. The conveyor belt then moves the cartridge 54 to the laser cutting station LC, for cutting of the tubular ceramic green bodies using a laser cutter 62. The actions within each of the stations can be the same as described herein where different or the same ceramic-forming layers can be applied in different printer stations.

In another aspect, the present teachings provide a method for producing tubular ceramic green bodies including:
providing a cartridge comprising a plurality of mandrel-spindle assemblies, the lengths of the plurality of mandrel-spindle assemblies being parallel to each other and in the same horizontal plane along the cartridge, wherein the cartridge is adapted to rotate each of the plurality of mandrel-spindle assemblies and wherein each of the mandrel-spindle assemblies comprises a mandrel component and a spindle component, the mandrel component being a heat shrinkable tube, a fugitive tube or a coating on the spindle component, the external surface of which corresponds to the internal surface of the tubular ceramic green body to be produced and the internal surface of which defines a bore, the spindle component being in close fitting but removable contact therewith;
rotating the plurality of mandrel-spindle assemblies and applying an anode-forming layer to each of the respective mandrels of the plurality of rotating mandrel-spindle assemblies of the cartridge to form a plurality of anode-forming green bodies about each respective spindle;
inspecting each of the plurality of anode-forming green bodies for defects;
rotating the plurality of anode-forming green bodies and applying an interface-forming layer to each of the respective anode-forming green bodies of the plurality of rotating anode-forming green bodies of the cartridge to form a plurality of multiple layered green bodies about each respective spindle;
inspecting each of the plurality multiple layered green bodies for defects;
rotating the plurality of multiple layered green bodies and applying an electrolyte-forming layer to each of the respective multiple layered green bodies of the plurality of rotating multiple layered green bodies of the cartridge to form a plurality of tubular ceramic green bodies about each respective spindle;
inspecting each of the plurality of tubular ceramic green bodies for defects; and
removing any spindle comprising a tubular ceramic green body which was identified as having a defect during the inspections, prior to firing the tubular ceramic green body.

In various embodiments, the methods include monitoring in real time the outside diameter of the plurality of anode-forming green bodies while applying the anode-forming layer(s), the plurality of multiple layered green bodies while applying the interface-forming layer(s), and/or the plurality of tubular ceramic green bodies while applying the electrolyte-forming layer(s).

In some embodiments, the methods include storing the cartridge in a storage station, wherein the storage station is adapted for storing a plurality of cartridges.

In certain embodiments, the method includes moving the cartridge to a first printer station for applying the anode-forming layer; moving subsequently the cartridge to a first inspection station; moving subsequently the cartridge to a second printer station for applying the interface-forming layer; moving subsequently the cartridge to a second inspection station; moving subsequently the cartridge to a third printer station for applying the electrolyte-forming layer; and moving subsequently the cartridge to a third inspection station.

In particular embodiments of the methods, at least two of the first printer station, the second printer station, and the third printer station are the same printer station. In certain embodiments, each of the first inspection station, the second inspection station, and the third inspection station is the same inspection station, for example, as shown in FIG. 4.

In various embodiment, the methods include moving the cartridges using a conveyor belt assembly and/or moving robotically.

In some embodiments, the methods include moving the cartridge from a storage station to the first printer station. In certain embodiment of methods, after moving subsequently the cartridge to the third inspection station, the methods include moving the cartridge to a storage station.

In various embodiments, the methods include inspecting visually. In some embodiments, inspecting visually comprises inspecting visually using a camera. In certain embodiments, inspecting visually using a camera comprises using a computer software program to identify a defect based on an image from the camera. In particular embodiments, inspecting visually comprises maintaining a record such as recording information of the inspection of a particular spindle of the cartridge. In some embodiments, the methods include one or more of recording the results of the inspection of the plurality of anode-forming green bodies; recording the results of the inspection of the plurality of multiple layered green bodies; and recording the results of the inspection of the plurality of tubular ceramic green bodies. In certain embodiments, the methods include recording the results of the inspection of one or more inert-forming layers. The recorded information can also include information of a layer as it is being applied.

In some embodiments of the methods, applying the anode-forming layer comprises varying the composition of the anode-forming layer. In certain embodiments, varying the composition of the anode-forming layer comprises applying the anode-forming layer using a different printer station. In particular embodiments, varying the composition of the anode-forming layer comprises changing the elemental composition of the anode-forming layer using the same printer station.

In some embodiments of the methods, varying the composition of the anode-forming layer comprises applying an inert-forming layer and/or an active catalyst-forming layer between anode-forming layers. In certain embodiments, applying an inert-forming layer and/or an active catalyst-forming layer between anode-forming layers comprises applying more than one inert-forming layers and/or active catalyst-forming layers, each between anode-forming layers or adjacent one anode-forming layer. In particular embodiments, an inert-forming layer can be the first applied layer forming the inside diameter of the tubular ceramic green body. In various embodiments, the first layer can include a higher level of inert and/or active catalyst materials to assist in tailoring the reactivity along the cell, to increase thermal shock resistance, reduce coke formation, and possibly offer some redox resistance. It should be understood that the anode-forming layer can include many different layers of varying composition including inert-forming layer(s) and active catalyst-forming layers.

Indeed, the present teachings include forming an inert tubular structure, for example, for forming thin walled ceramic tubes for a reformer and/or a cathode heat exchanger.

In various embodiments, the methods include cutting with a laser the tubular ceramic green bodies into pre-determined length segments along a spindle after recording the results of the inspections of the tubular ceramic green bodies but before removing the tubular ceramic green bodies from the spindles. In some embodiments, the cutting with the laser results in three or four equal length segments of tubular ceramic green bodies along each spindle. In certain embodiments, the cut tubular ceramic green bodies can be inspected as described herein including visual eye inspection.

In some embodiments, the anode-forming layer, interface-forming layer, electrolyte-forming layer include a solvent. In certain embodiments, the anode-forming layer, interface-forming layer, electrolyte-forming layer, active catalyst-forming layer, and/or inert-forming layer(s) include a solvent.

In various embodiments, the methods include removing the tubular ceramic green bodies from the spindles; and sintering the tubular ceramic green bodies. One or more further production operations can be performed on the tubular ceramic green bodies such as the formation thereon of one or more additional layers, for example, interlayer thin film(s) or a cathode layer, can occur either before or after sintering to burning out any organics and other materials assisting in the formation of a solid tubular ceramic structure such as a tubular ceramic green body.

Returning to FIG. 4, in general operation, the robotic tray 32 will engage with a cartridge 34′ in the storage station, moving the cartridge 34 from the storage station to the first printer station P1, where an anode-forming layer is applied to each of the respective mandrels of a plurality of rotating mandrel-spindle assemblies of the cartridge to form a plurality of anode-forming green bodies about each respective mandrel. The application of the layers is usually accomplished by printing or spraying such as by ultrasonic spraying of the ceramic-forming layer using a printer head 44.

The composition of the anode-forming layer can be varied as the layer is applied. For example, the ceramic composition can be varied by elemental composition (e.g., amount of ceramics, metal oxides and/or precious metals) or can be a completely different composition such an inert layer (it should be understood that the anode-forming layer can be considered to be made up of many different layers, each layer being a different composition). An inert layer can be useful to increase the thermal shock of the tubular SOFCs and/or for absorbing or filtering contaminants. An active catalyst layer can also serve this latter purpose, i.e., for absorbing, chemically modifying, and/or filtering contaminants.

Because of the time to apply the ceramic-forming layers, each printer station, or less than all but more than one printer station, can contain a cartridge to which ceramic-forming layers are applied to their rotating mandrel-spindle assemblies. In addition, it should be understood that a system of the present teachings can include more than three printer stations and/or more than three inspection stations, or two printer stations and/or two inspection stations, and more than one storage station and more than one laser cutting station. And that the number of each of these components, including storage stations, printer stations, inspection stations and laser cutting stations, can be in various combinations depending, in part, on the composition of the ceramic green bodies and timing of applying the layers to form the same.

For example, multiple printers can be dedicated to applying the various layers of the anode-forming layer, which can be about 70%-80% of the tubular ceramic green body and only one printer station dedicated to applying the electrolyte layer as it is thin and not time consuming to apply as it may be only about 5%-10% of the tubular ceramic green body.

As shown in FIG. 4, the first printer station includes a real-time outside diameter measurement device 38. The real-time outside diameter measurement device determines in real time the outside diameter of the respective applied ceramic-forming layer. Real time monitoring can assist in knowing when the appropriate amount of material has been applied and in particular, whether enough material has been laid down so that the layer will be of the appropriate thickness. In addition, subsequently added ceramic-forming layers can possibly cure a defect in a previously applied layer and/or a dimensional issue with a particular layer. That is, measuring the dimensions in real time can permit additional material to be applied to meet the specifications for that particular layer, for example, if measured thinner than specification. Thus, the real-time outside diameter measurement device improves the efficiency of the process and the production of working tubular SOFCs. The real time outside diameter measurement device can also be used to trigger an adjustment in the composition at a certain wall thickness.

Further, it should be realized that an anode-forming layer can be completed in the first printer station alone with the composition of the anode-forming layers being changed in in the first printer. Alternatively, the anode-forming layer can be completed in the first printer station and the second printer station and/or the third printer station (or more printer stations, if available). That is, different layers of the anode-forming layer can be applied in different printer stations, for example, an inert layer in the second printer station. In such a case, the robotic tray would move the cartridge from the first printer station to the second printer station and/or the third printer station. Similarly, the interface-forming layer and the electrolyte layer can be applied in one printer station or multiple printer stations. Although these layers tend to be thinner than the anode-forming layer such that one printer is typically sufficient, in particular, for the electrolyte-forming layer. It should be understood in particular embodiments that each printer station or a subset of printer stations can adjust the elemental composition of the applied ceramic-forming layers for versatility of the system.

After completion of the formation of the anode-forming layer (or intermittently, if needed or desired), the robotic tray can move the cartridge from the first printer station P1 (or from whatever printer station the anode-forming layer is completed) to the inspection station I, where the anode-forming layers on the mandrel-spindle assemblies are inspected for defects, for example, using a camera 40 to view uneven, cracked, or defective ceramic-forming layers. The camera can be connected to and use a computer software program to identify a defect based on an image from the camera, which is under the control of the controller.

In certain embodiments, the methods of the present teachings can include recording the results of the inspection of the plurality of anode-forming green bodies. The recording can be a digital recording, for example, using the computer software program for identifying the defect. The recording can include the cartridge identification information; position information, for example, the spindle number, the location along the length of the spindle; and the type of defect including a picture of the defect for visual inspection by an operator. Of course the recording can be the recording the results of the inspection of the plurality of multiple layered green bodies; and/or recording the results of the inspection of the plurality of tubular ceramic green bodies, where the same information can be recorded. Further, the recording can be of the inspection of an intermediate ceramic-forming layer, for example, an insert-forming layer.

After inspection of the anode-forming layer, the robotic tray can move the cartridge to a second printer station P2, wherein an interface-forming layer can be applied to each of the respective anode-forming green bodies of a plurality of rotating anode-forming green bodies of the cartridge to form a plurality of multiple layered green bodies about each respective mandrel. The second printer station P2 has a printer head 44′ and an outside diameter measurement device 38′ similar to the first printer station P1.

After completion of the formation of the interface-forming layer (or intermittently, if needed or desired), the robotic tray can move the cartridge from the second printer station P2 (or from whatever printer station the interface-forming layer is completed) to the inspection station I, where the interface-forming layers on the mandrel-spindle assemblies are inspected for defects, similar to what was done for the anode-forming layer. Recording of the defects or lack of defects, and related information, can be done as for the first inspection of the anode-forming layer.

After inspection of the interface-forming layer, the robotic tray can move the cartridge to a third printer station P3, wherein the electrolyte-forming layer can be applied to each of the respective multiple layered green bodies of a plurality of rotating multiple layered green bodies of the cartridge to form a tubular ceramic green body. The third printer station P3 has a printer head 44″ and an outside diameter measurement device 38″ similar to the first printer station P1 and the second printer station P2.

After completion of the formation of the electrolyte-forming layer (or intermittently, if needed or desired), the robotic tray can move the cartridge from the third printer station P3 (or from whatever printer station the electrolyte-forming layer is completed) to the inspection station I, where the electrolyte-forming layers on the mandrel-spindle assemblies are inspected for defects, similar to what was done for the anode-forming layer and the interface-forming layer. Recording of the defects or lack of defects, and related information, can be done as for the first inspection of the anode-forming layer or the second inspection of the interface-forming layer, or any intermediate ceramic-forming layer that underwent inspection.

After completion of the inspection of the tubular ceramic green bodies including electrolyte-forming layer, the robotic tray can move the cartridge from the inspection station I to the laser cutting station LC, where cutting with a laser cutter 42 the tubular ceramic green bodies into pre-determined length segments along a spindle can be implement, usually after identifying the results of the inspections of the tubular ceramic green bodies but before removing the tubular ceramic green bodies from the spindles. In certain embodiments, cutting with the laser results in two, three, four, or five equal length segments of tubular ceramic green bodies along each spindle. The laser can cut the ends of the tubes evenly and with a perpendicular structure. The laser can also be used to cut holes in the tubular ceramic green bodies. The laser can form tapered ends, for example, for manifolding and current collection. Other shapes and apertures can be formed as well using a laser depending on the particular application and need.

After laser cutting or after formation of the tubular ceramic green bodies, the completed cartridge can be returned to the storage station S or to a second storage station (not shown) specific for completed tubular ceramic green bodies. The storage station typically is temperature and humidity controlled so that the integrity of the completed tubular ceramic green bodies can be properly maintained before firing, for example, preventing the complete drying of the outside ceramic-forming layer(s).

The system of the present teachings depicted in FIG. 4 contains a controller C, which automates and controls the movement of the robotic tray and/or other robotic device(s) necessary to move the cartridge from the first print station to the inspection station, to the second printer station and the inspection station, and to the third printer station and the inspection station, or in whatever order is needed to form the desired tubular ceramic green body. The movement of the cartridge can be accomplished in a variety of ways, for example, a wheeled robotic device or a device on a track or rail that can move back and forth and to and from the different components of the system to place and remove the cartridges in each station. The controller can control the rotation of the mandrel-spindle assemblies including with subsequent ceramic-forming layers thereon. The controller can control the elemental composition of the ceramic-forming layer being applied and can vary it during application, for example, in one printer station. The controller can operate the outside diameter measurement devices, the camera, inspection of the images of the camera for defects, recording the results of the inspections with the information as described herein. The controller also can operate laser cutting station including laser placement and operation. The controller also can operation the movement of the cartridge from a storage station to a first printer station, and from the laser cutting station to a storage station (e.g., a second storage station for completed tubular ceramic-forming green bodies). The controller can operate the storage stations, for example, maintain their temperature and humidity at pre-determined numbers or ranges.

FIG. 5 includes a controller C′, similar to the controller in FIG. 4 but operating a conveyor belt rather than robotics, but in most other features the same.

In another aspect, the methods of the present teachings include a method of forming multiple tubular ceramic green bodies comprising:
providing a cartridge comprising a plurality of mandrel-spindle assemblies, the lengths of the plurality of mandrel-spindle assemblies being parallel to each other and in the same horizontal plane along the cartridge, wherein the cartridge is adapted to rotate each of the plurality of mandrel-spindle assemblies and wherein each of the mandrel-spindle assemblies comprises a mandrel component and a spindle component, the mandrel component being a heat shrinkable tube, a fugitive tube or a coating on the spindle component, the external surface of which corresponds to the internal surface of the tubular ceramic green bodies thereon and the internal surface of which defines a bore, the spindle component being in close fitting but removable contact therewith; and
cutting with a laser the tubular ceramic green bodies into multiple, smaller tubular ceramic green bodies along each spindle.

In various embodiments, the laser can be a carbon dioxide laser such as a 120 W CO₂ laser from Trotec Laser GmbH.

In various embodiments of the methods, the tubular ceramic green body comprises a solvent. In certain embodiments, the multiple, smaller tubular ceramic green bodies are equal in length.

### INCORPORATION BY REFERENCE

The entire disclosure of each of the patent documents and scientific articles referred to herein is incorporated by reference for all purposes.

### EQUIVALENTS

The disclosure may be embodied in other specific forms without departing from the spirit or essential characteristics thereof. The foregoing embodiments are therefore to be considered in all respects illustrative rather than limiting the disclosure described herein. Scope of the disclosure is thus indicated by the appended claims rather than by the foregoing description, and all changes that come within the meaning and range of equivalency of the claims are intended to be embraced therein ..

What is claimed is:

1. A method for producing tubular ceramic green bodies comprising:
providing a cartridge comprising a plurality of mandrel-spindle assemblies, the lengths of the plurality of mandrel-spindle assemblies being parallel to each other and in the same horizontal plane along the cartridge, wherein the cartridge is adapted to rotate each of the plurality of mandrel-spindle assemblies and wherein each of the mandrel-spindle assemblies comprises a mandrel component and a spindle component, the mandrel component being a heat shrinkable tube, a fugitive tube or a coating on the spindle component, the external surface of which corresponds to the internal surface of the tubular ceramic green body to be produced and the internal surface of which defines a bore, the spindle component being in close fitting but removable contact therewith;
rotating the plurality of mandrel-spindle assemblies and applying an anode-forming layer to each of the respective mandrels of the plurality of rotating mandrel-spindle assemblies of the cartridge to form a plurality of anode-forming green bodies about each respective spindle;
inspecting each of the plurality of anode-forming green bodies for defects;
rotating the plurality of anode-forming green bodies and applying an interface-forming layer to each of the respective anode-forming green bodies of the plurality of rotating anode-forming green bodies of the cartridge to form a plurality of multiple layered green bodies about each respective spindle;
inspecting each of the plurality of multiple layered green bodies for defects;
rotating the plurality of multiple layered green bodies and applying an electrolyte-forming layer to each of the respective multiple layered green bodies of the plurality of rotating multiple layered green bodies of the cartridge to form a plurality of tubular ceramic green bodies about each respective spindle;
inspecting each of the plurality of tubular ceramic green bodies for defects; and
removing any spindle comprising a tubular ceramic green body which was identified as having a defect during the inspections, prior to firing the tubular ceramic green body.

2. The method of claim 1, comprising one or more of monitoring in real time the outside diameter of the plurality of anode-forming green bodies while applying the anode-forming layer, monitoring in real time the outside diameter of the plurality of multiple layered green bodies while applying the interface-forming layer, and monitoring in real time the outside diameter of the plurality of tubular ceramic green bodies while applying the electrolyte-forming layer.

3.-6. (canceled).

7. The method of claim 1, comprising storing the cartridge in a storage station, wherein the storage station is adapted for storing a plurality of cartridges.

8. The method of claim 1, wherein the method comprises;
moving the cartridge to a first printer station for applying the anode-forming layer;
moving subsequently the cartridge to a first inspection station;
moving subsequently the cartridge to a second printer station for applying the interface-forming layer;
moving subsequently the cartridge to a second inspection station;
moving subsequently the cartridge to a third printer station for applying the electrolyte-forming layer; and
moving subsequently the cartridge to a third inspection station.

9.-10. (canceled).

11. The method of claim 8, wherein moving comprises moving using a conveyor belt assembly and/or moving robotically.

12. The method of claim 8, comprising moving the cartridge from a storage station to the first printer station.

13. The method of claim 8, comprising, after moving subsequently the cartridge to the third inspection station, moving the cartridge to a storage station.

14. (canceled)

15. The method of claim 1, wherein inspecting comprises inspecting visually using a camera.

16. The method of claim 15, wherein inspecting visually using a camera comprises using a computer software program to identify a defect based on an image from the camera.

17. The method of claim 16, wherein inspecting visually using a camera comprises maintaining information of the inspection of a particular spindle of the cartridge.

18. The method of claim 1, wherein applying an anode-forming layer comprises varying the composition of the anode-forming layer.

19. The method of claim 18, wherein varying the composition of the anode-forming layer comprises applying the anode-forming layer using a different printer station.

20. The method of claim 18, wherein the varying the composition of the anode-forming layer comprises changing the composition of the anode-forming layer using the same printer station.

21. The method of claim 18, wherein varying the composition of the anode-forming layer comprises applying an inert-forming layer and/or an active catalyst-forming layer between anode-forming layers.

22.-23. (canceled).

24. The method of claim 1, comprising cutting with a laser the tubular ceramic green bodies into pre-determined length segments along a spindle after recording the results of the inspections of the tubular ceramic green bodies but before removing the tubular ceramic green bodies from the spindles.

25. (canceled)

26. The method of claim 1, wherein the anode-forming layer, interface-forming layer, electrolyte-forming layer comprise a solvent.

27. (canceled)

28. (canceled)

29. The method of claim 1, comprising:
removing the tubular ceramic green bodies from the spindles; and
sintering the tubular ceramic green bodies.

30. A method of forming multiple tubular ceramic green bodies comprising:
providing a cartridge comprising a plurality of mandrel-spindle assemblies, the lengths of the plurality of mandrel-spindle assemblies being parallel to each other and in the same horizontal plane along the cartridge, wherein the cartridge is adapted to rotate each of the plurality of mandrel-spindle assemblies and wherein each of the mandrel-spindle assemblies comprises a mandrel component and a spindle component, the mandrel component being a heat shrinkable tube, a fugitive tube or a coating on the spindle component, the external surface of which corresponds to the internal surface of the tubular ceramic green bodies thereon and the internal surface of which defines a bore, the spindle component being in close fitting but removable contact therewith, and a tubular ceramic green body about each mandrel-spindle assembly; and
cutting with a laser the tubular ceramic green bodies into multiple, smaller tubular ceramic green bodies along each mandrel-spindle assembly.

31.-32. (canceled).

33. A system for producing tubular ceramic green bodies comprising:
a cartridge comprising a plurality of mandrel-spindle assemblies, the lengths of the plurality of mandrel-spindle assemblies being parallel to each other and in the same plane along the cartridge, wherein the cartridge is adapted to rotate each of the plurality of mandrel-spindle assemblies and wherein each of the mandrel-spindle assemblies comprises a mandrel component and a spindle component, the mandrel component being a heat shrinkable tube, a fugitive tube or a coating on the spindle component, the external surface of which corresponds to the internal surface of the tubular ceramic green body to be produced and the internal surface of which defines a bore, the spindle component being in close fitting but removable contact therewith;
a first printer station, wherein an anode-forming layer is applied to each of the respective mandrels of a plurality of rotating mandrel-spindle assemblies of the cartridge to form a plurality of anode-forming green bodies about each respective mandrel;
a second printer station, wherein an interface-forming layer is applied to each of the respective anode-forming green bodies of a plurality of rotating anode-forming green bodies of the cartridge to form a plurality of multiple layered green bodies about each respective mandrel;
a third printer station, wherein the electrolyte-forming layer is applied to each of the respective multiple layered green bodies of a plurality of rotating multiple layered green bodies of the cartridge to form a tubular ceramic green body;
an inspection station, wherein the anode-forming layer, the interface-forming layer, and the electrolyte-forming layer are inspected for defects after their formation and the identity of any mandrel-spindle assembly of the cartridge having any defects is identified; and
a controller to automate the movement of the cartridge from the first print station to the inspection station, to the second printer station and the inspection station, and to the third printer station and the inspection station.

34.-35. (canceled).

36. The system of claim 33, comprising a laser cutting station, wherein the cartridge comprising rotating tubular ceramic green bodies has its tubular ceramic green bodies exposed to a laser along a width of the tubular ceramic green bodies to form multiple tubular ceramic green bodies along the spindle having smaller lengths than before exposure to the laser.

37.-38. (canceled).
